(19) United States
(12) Patent Application Publication
(10) Pub. No.: US 2020/0257109 A1
(43) Pub. Date: Aug. 13, 2020

(54) OPTICAL SYSTEM

(71) Applicant: CANON KABUSHIKI KAISHA, Tokyo (JP)

(72) Inventor: Hiroto Kano, Utsunomiya-shi (JP)

(21) Appl. No.: 16/774,056

(22) Filed: Jan. 28, 2020

(30) Foreign Application Priority Data
Feb. 8, 2019 (JP) 2019-021194

(51) Int. Cl. G02B 27/00; G02B 9/34; G02B 9/60; G02B 13/18

(52) U.S. Cl. CPC G02B 27/0031; G02B 13/18; G02B 9/60; G02B 9/34

(57) ABSTRACT

In order to provide an optical system capable of sufficiently reducing chromatic aberration, the optical system according to the present invention is an optical system including a plurality of lenses in which the following conditional expression is satisfied:

$$\vert \frac{{Σ}_{i} \frac{1}{{υ}_{i} {N}_{i}^{2}} ( {φ}_{i {1}^{+}} {φ}_{i 2} )}{f} \vert \leq 3 \times 1 {0}^{- 3} ,$$

where f is a focal length of the optical system, i is an order of each of the plurality of lenses counted from an enlargement side, Rᵢ₁ and Rᵢ₂ are curvature radii of lens surfaces of an i-th lens at the enlargement side and a reduction side in a cross section including an optical axis, respectively, Nᵢ and νᵢ are a refractive index and an Abbe number of the i-th lens, respectively, φᵢ₁=(Nᵢ−1)/Rᵢ₁, and φᵢ₂=(1−Nᵢ)/Rᵢ₂.

### BACKGROUND OF THE INVENTION

### Field of the Invention

The present invention relates to an optical system and is preferably used in particular in an image reading apparatus.

### Description of the Related Art

Heretofore, there has been a demand for improvement in accuracy of the optical systems in image reading apparatuses in order to finely read image information from a subject.

Japanese Patent Application Laid-Open No. 2017-187663 discloses an optical system capable of reducing chromatic aberration resulting from the difference between the field curvatures for different colors by using two optical elements which have aspheric surfaces rotationally asymmetric about the optical axis and are made of different materials.

The optical system disclosed in Japanese Patent Application Laid-Open No. 2017-187663 is not good enough to achieve the further chromatic aberration correction performance demanded in the recent years for image reading apparatuses.

In view of the above, an object of the present invention is to provide an optical system capable of sufficiently reducing chromatic aberration.

### SUMMARY OF THE INVENTION

An optical system according to the present invention is an optical system including a plurality of lenses in which the following conditional expression is satisfied:

$$\vert \frac{{\sum }_{i} \frac{1}{{v}_{i} {N}_{i}^{2}} ( {φ}_{i {1}^{+}} {φ}_{i 2} )}{f} \vert \leq 3 \times 1 {0}^{- 3} ,$$

where f is a focal length of the optical system, i is an order of each of the plurality of lenses counted from an enlargement side, Rᵢ₁ and Rᵢ₂ are curvature radii of lens surfaces of an i-th lens at the enlargement side and a reduction side in a cross section including an optical axis, respectively, Nᵢ and νᵢ are a refractive index and an Abbe number of the i-th lens, respectively, (φᵢ₁=(Nᵢ−1)/Rᵢ₁, and φᵢ₂=(1−Nᵢ)/Rᵢ₂.

Further features of the present invention will become apparent from the following description of exemplary embodiments with reference to the attached drawings.

### BRIEF DESCRIPTION OF THE DRAWINGS

FIG. 1 is a schematic cross-sectional view of an image reading apparatus equipped with an optical system according to an embodiment of the present invention.

FIG. 2A is a schematic cross-sectional view of an exemplary refraction surface having a curvature radius.

FIG. 2B is a schematic cross-sectional view of an exemplary single lens placed in the air.

FIG. 3A is a diagram schematically illustrating focal depths of a conventional optical system.

FIG. 3B is a diagram schematically illustrating focal depths of the optical system according to the embodiment.

FIG. 4 is a cross-sectional view of an optical system according to Numerical Example 1 of the embodiment.

FIG. 5 is a cross-sectional view of an optical system according to Numerical Example 2 of the embodiment.

FIG. 6 is a cross-sectional view of an optical system according to Numerical Example 3 of the embodiment.

FIG. 7 is a set of aberration diagrams of the optical system according to Numerical Example 1 of the embodiment.

FIG. 8 is a set of aberration diagrams of the optical system according to Numerical Example 2 of the embodiment.

FIG. 9 is a set of aberration diagrams of the optical system according to Numerical Example 3 of the embodiment.

FIG. 10 is a diagram schematically illustrating the shape of part of an aspheric surface included in the optical system according to the embodiment.

### DESCRIPTION OF THE EMBODIMENTS

An optical system according to an embodiment of the present invention will be described below with reference to the drawings. Note that the drawings presented below may be depicted with different scales from the actual ones in order to facilitate understanding of the embodiment.

The optical system according to the embodiment is preferably usable as a reading lens unit, i.e., a reading optical system, which is mounted in particular in an image reading apparatus such as an image scanner, a photocopier, or a facsimile and condenses reflected light containing image information from an original on the light receiving surface of an image pickup element.

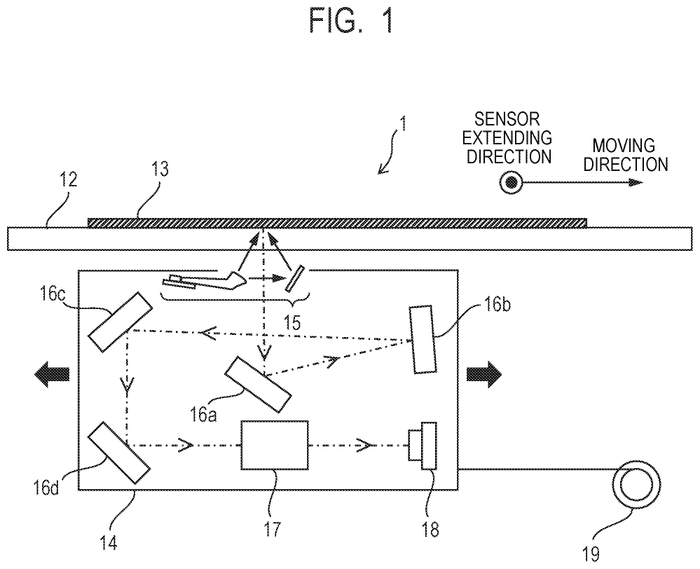

FIG. 1 illustrates a schematic cross-sectional view of an image reading apparatus 1 equipped with an optical system 17 according to the embodiment.

The image reading apparatus 1 includes a platen glass 12, a carriage 14, an illumination unit 15, first, second, third, and fourth reflection mirrors 16a, 16b, 16c, and 16d, the optical system 17, an image pickup element 18 (light receiving unit), and a motor 19.

Note that the illumination unit 15 consists of a light source such as an LED, a fluorescent lamp, or a halogen lamp, a light guide, a light reflector, and so on.

Also, a charge coupled device (CCD) sensor, a complementary metal oxide semiconductor (CMOS) sensor, or the like which extends in a one-dimensional direction is used as the image pickup element 18. Moreover, the image pickup element 18 is disposed along an extending direction (first direction) in a first cross section parallel to the platen glass 12.

Also, the illumination unit 15, the first, second, third, and fourth reflection mirrors 16a, 16b, 16c, and 16d, the optical system 17, and the image pickup element 18 are disposed in the carriage 14 and are movable integrally with the carriage 14.

As illustrated in FIG. 1, in the image reading apparatus 1, an original 13 (subject, object) placed on the platen glass 12 is illuminated by the illumination unit 15.

Then, the reflected light flux from the illuminated original 13 (image information) is reflected by the first, second, third, and fourth reflection mirrors 16a, 16b, 16c and 16d such that its optical path is bent, and guided to (condensed on) the light receiving surface of the image pickup element 18 by the optical system 17.

Further, the carriage 14 is moved by the motor 19 in a moving direction (second direction) perpendicular to the extending direction of the image pickup element 18 within the first cross section, so that image information on the original 13 can be obtained two-dimensionally.

The optical system 17 according to the embodiment satisfies the following conditional expression (1) where f is the focal length of the optical system 17, i is the order of each of the plurality of lenses forming the optical system 17 counted from the enlargement side, φᵢ₁ is the power of the incident surface (the lens surface on the enlargement side) of an i-th lens Li (i=1, 2, . . . , k) for the d-line, φᵢ₂ is the power of the exit surface (the lens surface of the reduction side) of the i-th lens Li for the d-line, and Nᵢ and νᵢ are the refractive index and the Abbe number of the i-th lens Li for the d-line, respectively.

$$\vert \frac{{\sum }_{i = 1}^{k} \frac{1}{{v}_{i} {N}_{i}^{2}} ( {φ}_{i {1}^{+}} {φ}_{i 2} )}{f} \vert \leq 3 \times 1 {0}^{- 3} \qquad ( 1 )$$

Note that the conditional expression (1) is preferably satisfied for the e-line as well.

Next, a description will be given of the derivation of conditional expressions for reducing the chromatic aberration of the optical system 17 according to the embodiment resulting from the difference between the field curvatures for different colors.

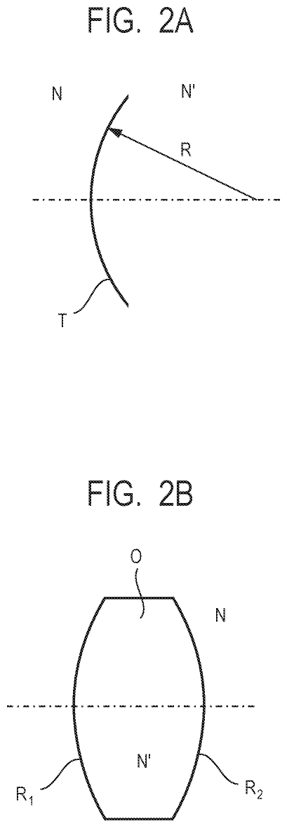

FIG. 2A illustrates an exemplary refraction surface T having a curvature radius R.

Here, assume that a light beam enters the refraction surface T from the left side of the sheet of FIG. 2A and then exits to the right side of the sheet of FIG. 2A. In this case, power φ of the refraction surface T is expressed by the expression (2) given below:

$$φ = \frac{{N}^{′} - N}{R} , \qquad ( 2 )$$

where N is the refractive index of a medium A on the incident side for the light beam, and N′ is the refractive index of a medium B on the exit side for the light beam.

Here, Petzval curvature P of the refraction surface T is expressed by the expression (3) given below by using the expression (2):

$$P = \frac{φ}{{NN}^{′}} = \frac{1}{{NN}^{′}} \times \frac{{N}^{′} - N}{R} = \frac{1}{R} ( \frac{1}{N} - \frac{1}{{N}^{′}} ) . \qquad ( 3 )$$

Further, a change SP in the Petzval curvature P by a change in the refractive index N′ of the medium B is expressed by the expression (4) given below from the expressions (2) and (3).

$$δ P = \frac{\partial }{\partial {N}^{′}} [ \frac{1}{R} ( \frac{1}{N} - \frac{1}{{N}^{′}} ) ] δ {N}^{′} = \frac{1}{R} \times \frac{δ {N}^{′}}{{( {N}^{′} )}^{2}} = \frac{1}{{( {N}^{′} )}^{2}} \times \frac{δ {N}^{′}}{{N}^{′} - N} \times \frac{{N}^{′} - N}{R} = \frac{1}{{( {N}^{′} )}^{2}} \times \frac{φ}{v} \qquad ( 4 )$$

Here, ν is the Abbe number and is defined by the expression (5) given below:

$$υ = \frac{{N}^{′} - N}{δ {N}^{′}} . \qquad ( 5 )$$

Next, consider a single lens O placed in the air as illustrated in FIG. 2B.

Here, assume that a light beam enters the incident surface of the single lens O from the left side of the sheet of FIG. 2B and then exits from the exit surface of the single lens O to the right side of the sheet of FIG. 2B. In this case, the change δP in the Petzval curvature P of this single lens O can be derived by the expression (6) given below from the expression (4), where N′ is the refractive index of the single lens O, N (=1.0) is the refractive index of the air, and R₁ and R₂ are the curvature radii of the incident surface and the exit surface of the single lens O, respectively.

$$δ P = \frac{1}{{R}_{1}} \times \frac{δ {N}^{′}}{{( {N}^{′} )}^{2}} - \frac{1}{{R}_{2}} \times \frac{δ {N}^{′}}{{( {N}^{′} )}^{2}} = \frac{1}{{( {N}^{′} )}^{2}} \times \frac{δ {N}^{′}}{{N}^{′} - N} \times ( \frac{{N}^{′} - N}{{R}_{1}} - \frac{{N}^{′} - N}{{R}_{2}} ) = \frac{1}{{( {N}^{′} )}^{2}} \times \\ \frac{1}{υ} \times ( {φ}_{1} + {φ}_{2} ) \qquad ( 6 )$$

Here, the powers φ₁ and φ₂ of the incident surface and the exit surface are defined by the expressions (7) and (8) given below, respectively, and the Abbe number ν is expressed by the expression (9) given below.

$$\begin{matrix}{φ}_{1} = \frac{{N}^{′} - N}{{R}_{1}} = \frac{{N}^{′} - 1}{{R}_{1}} & ( 7 ) \\ {φ}_{2} = \frac{N - {N}^{′}}{{R}_{2}} = \frac{1 - {N}^{′}}{{R}_{2}} & ( 8 ) \\ υ = \frac{{N}^{′} - N}{δ {N}^{′}} = \frac{{N}^{′} - 1}{δ {N}^{′}} & ( 9 )\end{matrix}$$

Based on the above, the change δP in the Petzval curvature P in an optical system consisting of k lenses is expressed by the expression (10) given below.

$$δ P = {\sum }_{i = 1}^{k} δ {P}_{i} = {\sum }_{i = 1}^{k} \frac{1}{{( {N}_{i}^{′} )}^{2}} \times \frac{1}{{υ}_{i}} \times ( {φ}_{i 1} + {φ}_{i 2} ) \qquad ( 10 )$$

Here, N′ᵢ, νᵢ, φᵢ₁, and φᵢ₂ are the refractive index and the Abbe number of the i-th lens, and the power of the incident surface of the i-th lens, and the power of the exit surface of the i-th lens, respectively. Also, the power φᵢ₁ of the incident surface of the i-th lens and the power φᵢ₂ of the exit surface of the i-th lens are derived from φᵢ₁=(N′ᵢ−1)/Rᵢ₁ and φᵢ₂=(1−N′ᵢ)/Rᵢ₂, respectively, where Rᵢ₁ and Rᵢ₂ are the curvature radii of the incident surface and the exit surface of the i-th lens in a cross section including the optical axis, respectively.

Here, reducing the value represented by the expression (10) can reduce the difference between the Petzval sums for different colors, that is, it is possible to reduce the chromatic aberration resulting from the difference between the field curvatures for the colors. [0043]1 The inventor of the present application has then found out that a good optical system can be obtained by satisfying the conditional expression (1) given above.

When the ratio exceeds the upper limit value in the conditional expression (1), it becomes difficult to sufficiently reduce the chromatic aberration resulting from the difference between the field curvatures for the colors.

Also, the optical system 17 according to the embodiment preferably satisfies the conditional expression (1a) given below:

$$1 \times 1 {0}^{- 5} \leq \vert \frac{{Σ}_{i = 1}^{k} \frac{1}{{υ}_{i} {N}_{i}^{2}} ( {φ}_{i {1}^{+}} {φ}_{i 2} )}{f} \vert \leq 2 \times 1 {0}^{- 3} . \qquad ( 1 a )$$

In this case, by exceeding the lower limit value in the conditional expression (1a), the lateral chromatic aberration can be also corrected well.

Further, the optical system 17 according to the embodiment more preferably satisfies the conditional expression (1b) given below:

$$1 \times 1 {0}^{- 5} \leq \vert \frac{{Σ}_{i = 1}^{k} \frac{1}{{υ}_{i} {N}_{i}^{2}} ( {φ}_{i {1}^{+}} {φ}_{i 2} )}{f} \vert \leq 1 \times 1 {0}^{- 3} . \qquad ( 1 b )$$

Note that when the optical system 17 according to the embodiment is used in an image pickup apparatus or an image reading apparatus, the enlargement plane and the reduction plane are the object plane and the image plane (image pickup surface), respectively, and the enlargement side and the reduction side are the object side and the image side, respectively.

When the optical system 17 according to the embodiment includes an aspheric lens, a paraxial curvature radius or a curvature radius corresponding (approximated) thereto may be used for the aspheric lens.

When the optical system 17 according to the embodiment includes a reflection surface having power, the change δP in the Petzval curvature P of the reflection surface having power may be 0.

When the optical system 17 according to the embodiment includes a cemented lens formed by cementing two or more lenses, the change δP in the Petzval curvature P may be derived separately for each single lens in the cemented lens.

Next, a description will be given of advantageous effects achieved by reducing the chromatic aberration resulting from the difference between the field curvatures for different colors.

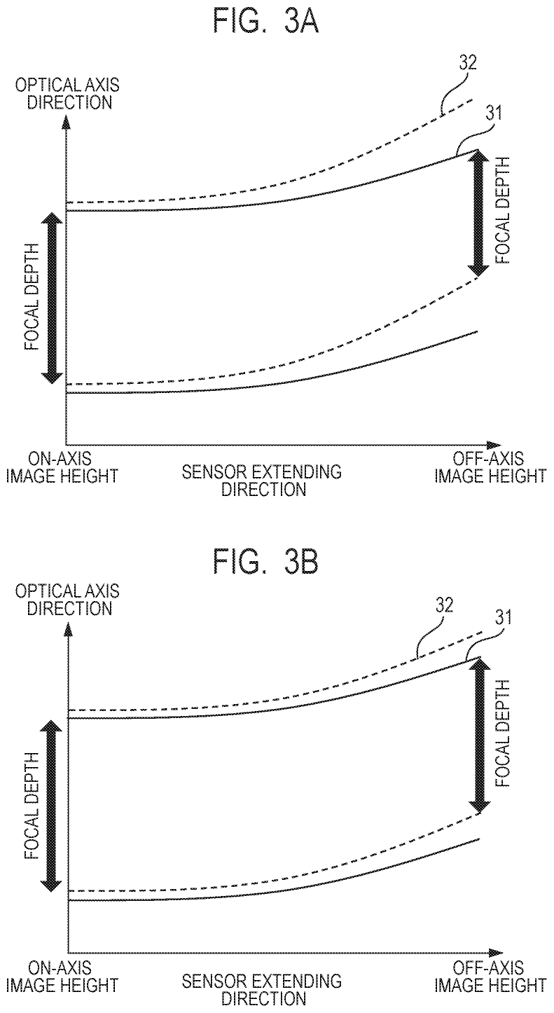

FIGS. 3A and 3B are diagrams schematically illustrating focal depths of a conventional optical system and focal depths of the optical system 17 according to the embodiment, respectively.

Here, solid lines 31 represent the focal depth for a reference wavelength (or reference color) while dashed lines 32 represent the focal depth for a predetermined wavelength (or color) different from the reference wavelength (or the reference color).

As illustrated in FIG. 3A, in the conventional optical system, the difference between the ends of the focal depths for the reference wavelength and the predetermined wavelength is large at an off-axis image height as compared to the difference at an on-axis image height.

This causes chromatic aberration resulting from the difference between the field curvatures for different colors and causes a difference in focal depth between the on-axis image height and an off-axis image height. As a result, the focal depth shared by the on-axis image height and the off-axis image height, i.e., shared depth, is reduced.

On the other hand, as illustrated in FIG. 3B, in the optical system 17 according to the embodiment, as compared to the conventional optical system, the chromatic aberration resulting from the difference between the field curvatures for different colors is reduced, so that the difference in focal depth between the on-axis image height and the off-axis image height can be reduced.

This can ensure a sufficient shared depth. Further, the increase in the shared depth is likely to bring about simpler adjustments and the like, so that a cost reduction and the like can be achieved.

Meanwhile, the optical system 17 according to the embodiment preferably satisfies the conditional expression (11) given below:

$$8.3 \leq \frac{L}{f} \leq 12.5 , \qquad ( 11 )$$

where f is the focal length of the optical system 17, and L is the distance on the optical axis from the reading plane (the object plane, the focal point on the enlargement side) of the optical system 17 to the image plane (reduction plane).

When the ratio exceeds the upper limit value in the conditional expression (11), the apparatus in which the optical system is disposed becomes increased in size and it becomes difficult to correct the axial chromatic aberration.

On the other hand, when the ratio falls below the lower limit value in the conditional expression (11), a resolution in periphery becomes decreased, accompanied by widening an angle of view, and it becomes difficult to reduce the field curvatures and the chromatic aberration resulting from the difference between the field curvatures for different colors.

Also, the optical system 17 according to the embodiment preferably satisfies the conditional expression (11a) given below:

$$9.0 \leq \frac{L}{f} \leq 12.0 . \qquad ( 11 a )$$

Further, the optical system 17 according to the embodiment more preferably satisfies the conditional expression (11b) given below:

$$10.0 \leq \frac{L}{f} \leq 11.5 . \qquad ( 11 b )$$

Also, the optical system 17 according to the embodiment preferably satisfies the conditional expressions (12) and (13) given below:

35≤νₙ (12), and

25≤νₚ−νₙ (13),

where νₙ is the Abbe number of the negative lens having the smallest Abbe number among one or more negative lenses included in the plurality of lenses forming the optical system 17, and νₚ is the Abbe number of the positive lens having the largest Abbe number among one or more positive lenses included in the plurality of lenses forming the optical system 17.

As described in the expression (6), the smaller the Abbe number ν, the larger the change δP in the Petzval curvature.

Generally, for achromatization, a glass material having a small Abbe number is selected for a negative lens, so that the change δP in the Petzval curvature of the negative lens tends to be large.

Thus, νₙ is set to satisfy the conditional expression (12) to thereby reduce the change δP in the Petzval curvature of the negative lens.

If νₙ is set excessively large, it will be difficult to correct the axial chromatic aberration and the lateral chromatic aberration. Thus, νₙ and νₚ just need to be set such that the difference between νₚ and νₙ satisfies the conditional expression (13).

Also, the optical system 17 according to the embodiment preferably satisfies the conditional expressions (12a) and (13a) given below:

40≤νₙ (12a), and

30≤νₚ−νₙ (13a).

Further, the optical system 17 according to the embodiment more preferably satisfies the conditional expressions (12b) and (13b) given below:

40≤νₙ≤95 (12b), and

30≤νₚ−νₙ≤55 (13b).

In this case, by falling below the upper limit values in the conditional expressions (12b) and (13b), the number of choices for the glass materials of the lenses can be increased.

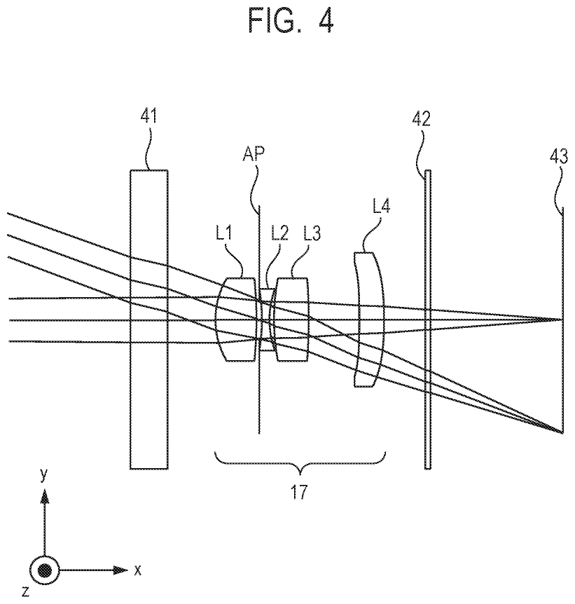

FIGS. 4, 5 and 6 are cross-sectional views of optical systems 17 according to Numerical Examples 1, 2 and 3 of the embodiment illustrated by developing optical paths, respectively.

Here, the reference numeral 41 denotes a platen glass, the reference numeral 42 denotes a cover glass, the reference numeral 43 denotes the imaging surface of the optical system 17, and the reference sign AP denotes an aperture stop. Note that the cover glass 42 is not included in the optical system 17, that is, the cover glass 42 does not contributes to imaging.

As shown in FIG. 4, the optical system 17 according to Numerical Example 1 includes a first lens L1 having positive power, a second lens L2 having negative power, a third lens L3 having positive power, and a fourth lens L4 having positive power.

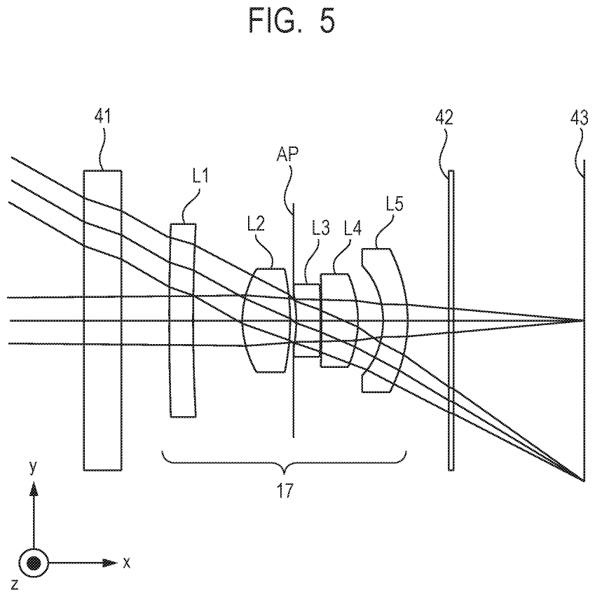

Also, as shown in FIG. 5, the optical system 17 according to Numerical Example 2 includes a first lens L1 having negative power, a second lens L2 having positive power, a third lens L3 having negative power, a fourth lens L4 having positive power, and a fifth lens L5 having negative power.

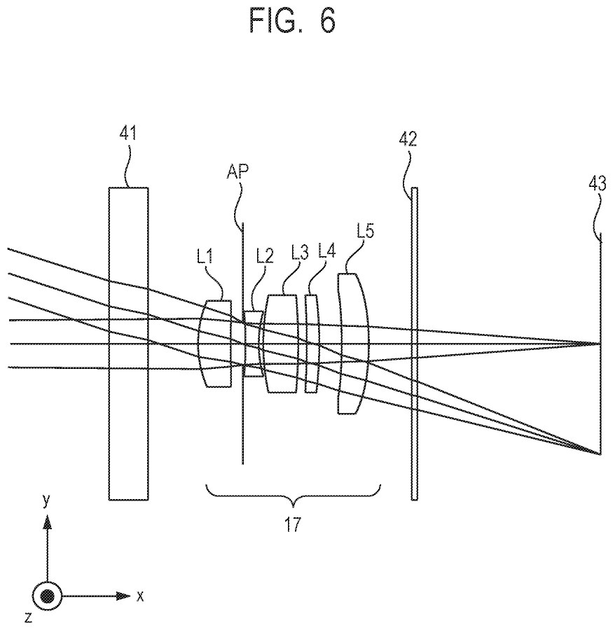

Further, as shown in FIG. 6, the optical system 17 according to Numerical Example 3 includes a first lens L1 having positive power, a second lens L2 having negative power, a third lens L3 having positive power, a fourth lens L4 having positive power, and a fifth lens L5 having positive power.

Note that another lens(es) may be included as necessary additionally in any of the above lens configurations.

Also, in the optical systems 17 according to Numerical Examples 1 to 3 of the embodiment, an aspheric lens is disposed closest to the reduction side.

Thus, the optical systems 17 according to Numerical Examples 1 to 3 of the embodiment have a triplet configuration with a positive lens, a negative lens, and a positive lens as a basic configuration, with an aspheric lens disposed closest to the reduction side to be separated farthest from the aperture stop AP. This enables an effective reduction of the field curvatures and distortion with a small number of lenses.

Also, in the optical systems 17 according to Numerical Examples 1 to 3 of the embodiment, the aperture stop is disposed between the positive lens disposed closest to the enlargement side and the negative lens disposed adjacent to the reduction side of the positive lens. This enables a reduction in the size accompanied by the effective diameter of the optical system.

Also, in the optical systems 17 according to Numerical Examples 1 to 3 of the embodiment, the lens surface at the enlargement side of the first lens disposed closest to the enlargement side is shaped to be convex toward the enlargement side, and the lens surface at the reduction side of the last lens disposed closest to the reduction side is shaped to be convex toward the reduction side. This suppresses reduction of the amount of peripheral light.

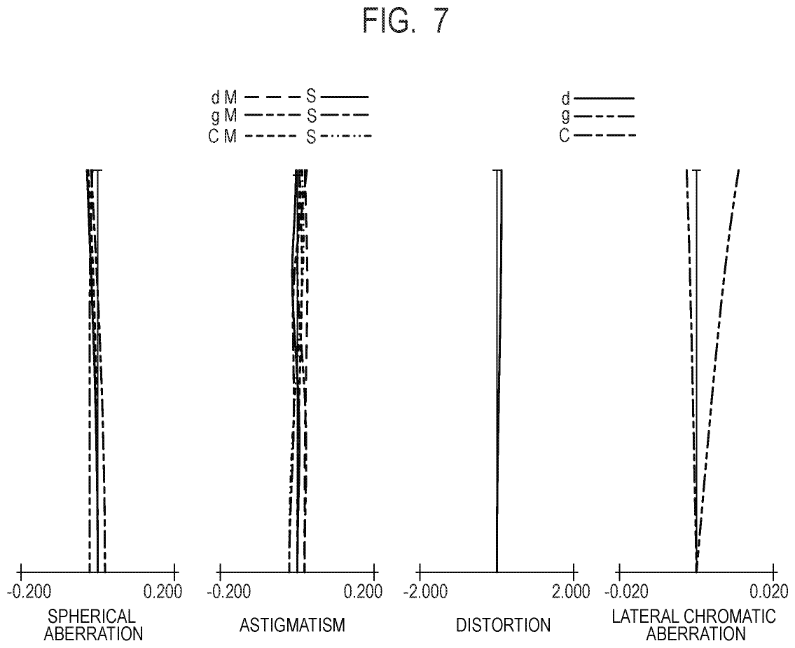

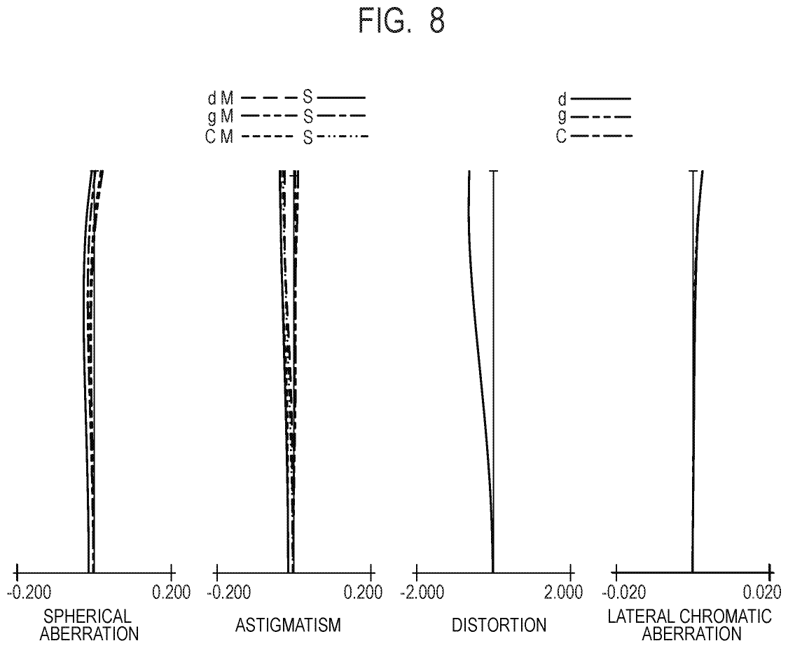

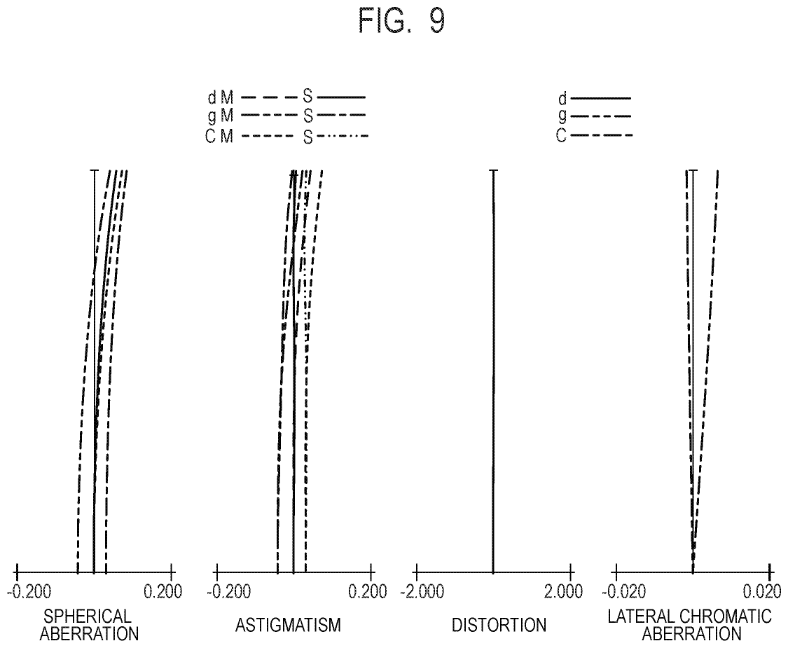

FIGS. 7, 8 and 9 illustrates sets of aberration diagrams of the optical systems 17 according to Numerical Examples 1, 2 and 3 of the embodiment, respectively.

Note that in each aberration diagram, the solid line represents the d-line, the long dashed double-short dashed line represents the g-line, and the long dashed short dashed line represents the C-line. In each astigmatism diagram, the solid line represents the sagittal direction, and the dotted line represents the meridional direction.

Next, Tables 1 to 3 list Numerical Data 1 to 3 corresponding to Numerical Examples 1 to 3 of the embodiment.

Here, j denotes the order (surface number) of the optical surface of each lens forming the optical system 17 from the enlargement side, Rj is the curvature radius of the j-th surface, Dj denotes the surface interval between the j-th surface and the j+1-th surface, and Ndj denotes the refractive index between the j-th surface and the j+1-th surface for the d-line.

Also, the curvature radius R is positive when the surface is concave toward the conjugate plane at the reduction side whereas is negative when the surface is convex toward the conjugate plane at the reduction side. The direction of the surface interval D is positive toward the conjugate plate at the reduction side.

Also, the Abbe number νdj of the optical member between the j-th surface and the j+1-th surface for the d-line is expressed by the expression (14) given below:

$${v}_{d j} = \frac{{N}_{d j} - {N}_{a i r}}{{N}_{F j} - {Nc}_{j}} . \qquad ( 14 )$$

Here, N_{Fj} is the refractive index between the j-th surface and the j+1-th surface for the F-line, N_{Cj} is the refractive index between the j-th surface and the j+1-th surface for the C-line, and Nₐᵢᵣ is the refractive index of air. Here, Nₐᵢᵣ=1.

Note that in Tables 1 to 3, the first surface and the second surface, which are closest to the enlargement side, correspond to the platen glass 41 while the last two surfaces, which are closest to the reduction side, correspond to the cover glass 42.

Also, in Numerical Data 1 to 3, the optical surfaces with “*” or “**” attached to their surface numbers represent special aspheric surfaces which are rotationally asymmetric, and the surfaces denoted as AP represent the aperture surface. Moreover, “E−x” means 10^{-x}.

Here, the aspheric surfaces with “*” will be described.

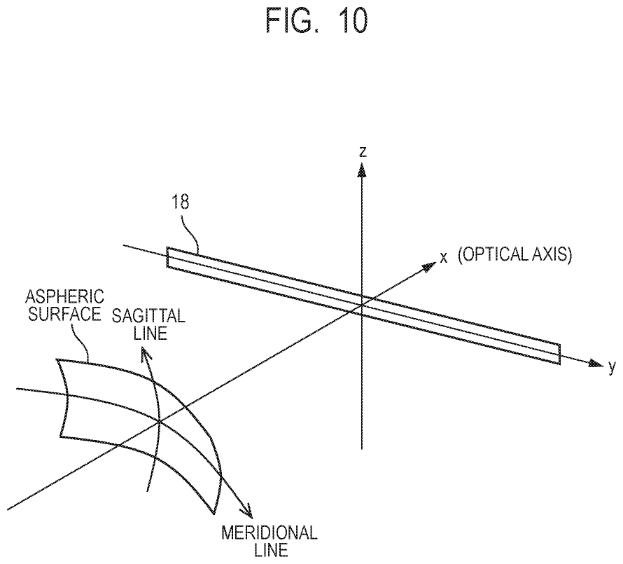

FIG. 10 schematically illustrates the shape of the aspheric surfaces with “*” included in the optical systems 17 according to Numerical Examples 1 and 3 of the embodiment.

As illustrated in FIG. 10, for the aspheric surfaces with “*”, when the direction parallel to the optical axis is an x axis and the pixel array direction of the image pickup element 18, which forms a reading unit, is a y axis, a line obtained by cutting the aspheric surface in the first cross section, which includes the optical axis and being parallel to the x axis and the y axis, is the meridional line.

Note that the optical axis is defined by the optical surfaces included in the optical system 17 that are rotationally symmetric about the optical axis.

Also, a line obtained by cutting the aspheric surface in a second cross section which is parallel to the optical axis and perpendicular to the first cross section is the sagittal line.

Here, on the aspheric surfaces with “*” of the special aspheric lenses included in the optical systems 17 according to Numerical Examples 1 and 3 of the embodiment, the curvature of the meridional line and the curvature of the sagittal line are equal to each other on the optical axis.

Moreover, on the aspheric surfaces with “*”, the curvature of the sagittal line continuously varies as it gets away from the optical axis in the y direction, i.e., from the on-axis image height toward the outermost off-axis image height.

Note that the curvature of the meridional line here refers to the curvature at any position on the meridional line within the first cross section. Also, the curvature of the sagittal line refers to the curvature at any position on the sagittal line within the second cross section at any position on the meridional line.

Further, a meridional line shape X of the aspheric surfaces with “*” is expressed by the expression (15) given below when the point of intersection of the aspheric surface and the optical axis of the optical system 17 is the origin, the direction parallel to the optical axis is the x axis, an axis perpendicular to the optical axis within the first cross section is the y axis, and an axis perpendicular to the optical axis within the second cross section is the z axis.

$$X = \frac{\frac{{y}^{2}}{R}}{1 + \sqrt{1 - ( 1 + {K}_{y} ) {( \frac{y}{R} )}^{2}}} + {B}_{4} {y}^{4} + {B}_{6} {y}^{6} + {B}_{8} {y}^{8} + {B}_{10} {y}^{10} \qquad ( 15 )$$

Here, R is a paraxial curvature radius, and K_{y}, B₄, B₆, B₈, and B₁₀ are aspherical coefficients.

Also, a sagittal line shape S of the aspheric surfaces with “*” (the amount of sag of the curvature radius on the optical axis relative to a reference shape in the x direction, which is parallel to the optical axis) is expressed by the expression (16) given below.

$$S = \frac{\frac{{z}^{2}}{{r}^{′}}}{1 + \sqrt{1 - ( 1 + {K}_{z} ) {( \frac{z}{{r}^{′}} )}^{2}}} + {\sum }_{i = 0}^{10} {D}_{i} {z}^{i} + {\sum }_{j = 0}^{10} {\sum }_{k = 0}^{6} {M}_{j k} {y}^{j} {z}^{k} \qquad ( 16 )$$

Here K_{z}, Dᵢ, and Mⱼₖ are aspherical coefficients. Also, the curvature radius r′ is expressed by the expression (17) given below.

$$\frac{1}{{r}^{′}} = \frac{1}{{r}_{0}} + {E}_{2} {y}^{2} + {E}_{4} {y}^{4} + {E}_{6} {y}^{6} + {E}_{8} {y}^{8} + {E}_{10} {y}^{10} \qquad ( 17 )$$

Here r₀ is the curvature radius on the optical axis, and E₂, E₄, E₆, E₈, and E₁₀ are aspherical coefficients.

Next, each aspheric surface AH with “**” included in the optical system 17 according to Numerical Example 2 of the embodiment is expressed by the expression (18) given below when the point of intersection of the aspheric surface and the optical axis of the optical system 17 is the origin, the direction parallel to the optical axis is the x axis, an axis perpendicular to the optical axis within the first cross section is the y axis, and an axis perpendicular to the optical axis within the second cross section is the z axis.

$$AH = \frac{\frac{{h}^{2}}{R}}{1 + \sqrt{1 - ( 1 + {K}_{A H} ) {( \frac{h}{R} )}^{2}}} + {\sum }_{i = 0}^{10} {\sum }_{j = 0}^{10} {C}_{i j} {y}^{i} {z}^{j} \qquad ( 18 )$$

Here R is a paraxial curvature radius, and K_{AH} and Cᵢⱼ are aspherical coefficients. Also, h is defined by the expression (19) given below:

h=\sqrt{y²+z²} (19).

Meanwhile, in Numerical Data 1 to 3, f denotes the focal length of the optical system 17, Fno denotes the F-number of the optical system 17 at the reduction side, β denotes the imaging magnification, H denotes the object height, and L denotes the entire length of the optical system 17.

### Numerical Example 1

TABLE 1

| | | | | | | name of | |
|---|---|---|---|---|---|---|---|
| surface | | | | | | glass | manufacturer |
| number | | Rj | Dj | Ndj | νdj | material | name |
| 1 | | ∞ | 3.90 | 1.516 | 64.14 | S-BSL7 | OHARA |
| 2 | | ∞ | 5.00 | 1.000 | | | |
| 3 | | 8.44 | 4.31 | 1.497 | 81.54 | S-FPL51 | OHARA |
| 4 | | −41.90 | 0.29 | 1.000 | | | |
| 5 | AP | ∞ | 0.28 | 1.000 | | | |
| 6 | | −19.29 | 0.80 | 1.613 | 44.27 | S-NBM51 | OHARA |
| 7 | | 9.43 | 0.47 | 1.000 | | | |
| 8 | | 23.34 | 3.65 | 1.772 | 49.60 | S-LAH66 | OHARA |
| 9 | | −55.06 | 5.31 | 1.000 | | | |
| 10 | * | −142.01 | 2.60 | 1.530 | 55.80 | E48R | ZEON |
| 11 | * | 38.33 | 4.30 | 1.000 | | | |
| 12 | | ∞ | 0.55 | 1.516 | 64.14 | S-BSL7 | OHARA |
| 13 | | ∞ | 13.91 | 1.000 | | | |

| | 10th | 11th |
|---|---|---|
| | surface | surface |
| R | −1.42E+02 | −3.83E+01 |
| Ky | 1.55E+02 | 1.09E+01 |
| B4 | −2.76E−04 | −1.78E−04 |
| B6 | 1.05E−07 | −3.48E−07 |
| B8 | −2.39E−08 | −9.41E−09 |
| B10 | 4.71E−10 | 1.02E−10 |
| r0 | −1.42E+02 | −3.83E+01 |
| Kz | 1.55E+02 | 1.09E+01 |
| D4 | −2.76E−04 | −1.78E−04 |
| D6 | 1.05E−07 | −3.48E−07 |
| D8 | −2.39E−08 | −9.41E−09 |
| D10 | 4.71E−10 | 1.02E−10 |
| E2 | 1.46E−03 | 1.52E−03 |
| E4 | −8.54E−05 | −5.91E−05 |
| E6 | 3.60E−06 | 2.11E−06 |
| E8 | −1.09E−07 | −5.47E−08 |
| E10 | 1.48E−09 | 5.66E−10 |
| M2_4 | −5.25E−04 | −5.20E−04 |
| M4_4 | 4.45E−05 | 3.53E−05 |
| M6_4 | −3.46E−06 | −2.07E−06 |
| M8_4 | 1.13E−07 | 5.29E−08 |
| M10_4 | −1.36E−09 | −4.98E−10 |
| M2_6 | 1.36E−04 | 1.43E−04 |
| M4_6 | −1.85E−05 | −1.23E−05 |
| M6_6 | 1.17E−06 | 5.19E−07 |
| M8_6 | −2.70E−08 | −9.39E−09 |
| M10_6 | 2.63E−10 | 8.60E−11 |

| | |
|---|---|
| f | 28.92 |
| Fno | 6.0 |
| β | −0.111 |
| H | 107.0 |
| L | 325.1 |

### Numerical Example 2

TABLE 2

| | | | | | | name of | |
|---|---|---|---|---|---|---|---|
| surface | | | | | | glass | manufacturer |
| number | | Rj | Dj | Ndj | νdj | material | name |
| 1 | | ∞ | 3.90 | 1.516 | 64.14 | S-BSL7 | OHARA |
| 2 | | ∞ | 5.00 | 1.000 | | | |
| 3 | ** | 302.12 | 2.50 | 1.531 | 55.75 | E48R | ZEON |
| 4 | ** | 185.00 | 5.14 | 1.000 | | | |
| 5 | | 10.48 | 5.00 | 1.439 | 94.93 | S-FPL53 | OHARA |
| 6 | | −25.58 | 0.33 | 1.000 | | | |
| 7 | AP | ∞ | 0.31 | 1.000 | | | |
| 8 | | −15.11 | 2.55 | 1.744 | 44.78 | S-LAM2 | OHARA |
| 9 | | −66.68 | 0.10 | 1.000 | | | |
| 10 | | −139.01 | 3.81 | 1.497 | 81.54 | S-FPL51 | OHARA |
| 11 | | −11.72 | 2.62 | 1.000 | | | |
| 12 | ** | −9.19 | 2.57 | 1.530 | 55.80 | E48R | ZEON |
| 13 | ** | −15.26 | 4.30 | 1.000 | | | |
| 14 | | ∞ | 0.55 | 1.516 | 64.14 | S-BSL7 | OHARA |
| 15 | | ∞ | 13.91 | 1.000 | | | |

| | 3rd | 4th | 12th | 13th |
|---|---|---|---|---|
| | surface | surface | surface | surface |
| R | 3.02E+02 | 1.85E+02 | −9.19E+00 | −1.53E+01 |
| K_{AH} | 0.00E+00 | 0.00E+00 | 5.13E−01 | −7.27E−01 |
| C0_4 | −1.71E−03 | −9.82E−04 | 1.29E−03 | −2.57E−03 |
| C2_2 | −4.19E−04 | −4.46E−04 | −3.61E−04 | −1.99E−04 |
| C4_0 | −8.69E−05 | −9.31E−05 | −1.80E−04 | −1.33E−04 |
| C0_6 | 0.00E+00 | 0.00E+00 | −8.90E−04 | −2.37E−04 |
| C2_4 | 3.52E−05 | 5.33E−05 | 2.95E−04 | 2.37E−04 |
| C4_2 | 1.14E−06 | 1.83E−06 | −9.09E−06 | −2.08E−06 |
| C6_0 | 5.64E−07 | 8.22E−07 | −1.19E−07 | 5.41E−07 |
| C0_8 | 0.00E+00 | 0.00E+00 | 1.96E−04 | 1.45E−04 |
| C2_6 | −6.12E−06 | −9.80E−06 | −1.69E−04 | −1.35E−04 |
| C4_4 | 1.18E−06 | 1.34E−06 | 1.03E−05 | 3.37E−06 |
| C6_2 | −1.93E−08 | −3.69E−08 | −9.97E−08 | −1.62E−08 |
| C8_0 | −2.44E−09 | −5.55E−09 | 8.38E−08 | 1.32E−08 |
| C0_10 | 0.00E+00 | 0.00E+00 | 0.00E+00 | 0.00E+00 |
| C2_8 | −2.45E−07 | 2.68E−07 | 2.23E−05 | 1.73E−05 |
| C4_6 | −1.70E−07 | −1.46E−07 | −1.40E−06 | −2.49E−07 |
| C6_4 | −8.05E−10 | −2.50E−09 | −5.19E−08 | −2.10E−08 |
| C8_2 | 1.12E−10 | 2.66E−10 | 7.70E−09 | 1.03E−09 |
| C10_0 | 1.45E−12 | 1.23E−11 | −9.43E−10 | −1.10E−10 |

| | |
|---|---|
| f | 26.48 |
| Fno | 5.0 |
| β | −0.111 |
| H | 152.0 |
| L | 300.2 |

### Numerical Example 3

TABLE 3

| | | | | | | name of | |
|---|---|---|---|---|---|---|---|
| surface | | | | | | glass | manufacturer |
| number | | Rj | Dj | Ndj | νdj | material | name |
| 1 | | ∞ | 3.90 | 1.516 | 64.14 | S-BSL7 | OHARA |
| 2 | | ∞ | 5.00 | 1.000 | | | |
| 3 | | 10.77 | 3.28 | 1.595 | 67.74 | S-FPM2 | OHARA |
| 4 | | 336.29 | 1.21 | 1.000 | | | |
| 5 | AP | ∞ | 0.27 | 1.000 | | | |
| 6 | | −34.07 | 1.33 | 1.702 | 41.24 | S-BAH27 | OHARA |
| 7 | | 11.41 | 0.45 | 1.000 | | | |
| 8 | | 23.03 | 3.50 | 1.652 | 58.55 | S-LAL7 | OHARA |
| 9 | | −54.79 | 0.86 | 1.000 | | | |
| 10 | | −80.02 | 1.25 | 1.538 | 74.70 | S-FPM3 | OHARA |
| 11 | | −39.69 | 2.24 | 1.000 | | | |
| 12 | * | −67.64 | 2.73 | 1.530 | 55.80 | E48R | ZEON |
| 13 | * | −25.19 | 4.30 | 1.000 | | | |
| 14 | | ∞ | 0.55 | 1.516 | 64.14 | S-BSL7 | OHARA |
| 15 | | ∞ | 18.37 | 1.000 | | | |

| | 12th | 13th |
|---|---|---|
| | surface | surface |
| R | −6.76E+01 | −2.52E+01 |
| Ky | 2.00E+01 | 5.45E−02 |
| B4 | −1.28E−04 | −8.40E−05 |
| B6 | −8.64E−07 | −8.94E−07 |
| B8 | −1.58E−08 | −8.60E−09 |
| B10 | 2.67E−10 | 3.68E−11 |
| r0 | −6.76E+01 | −2.52E+01 |
| Kz | 2.00E+01 | 5.45E−02 |
| D4 | −1.28E−04 | −8.40E−05 |
| D6 | −8.64E−07 | −8.94E−07 |
| D8 | −1.58E−08 | −8.60E−09 |
| D10 | 2.67E−10 | 3.68E−11 |
| E2 | 3.52E−04 | 5.55E−04 |
| E4 | −4.23E−06 | −7.91E−06 |
| E6 | −5.25E−08 | 2.06E−07 |
| E8 | −1.20E−08 | −1.02E−08 |
| E10 | 2.83E−10 | 1.19E−10 |
| M2_4 | 4.11E−05 | 3.42E−05 |
| M4_4 | −3.78E−06 | −2.47E−06 |
| M6_4 | 1.04E−08 | 8.21E−09 |
| M8_4 | 7.53E−10 | 2.34E−10 |
| M10_4 | 5.64E−12 | −2.58E−12 |
| M2_6 | 4.93E−06 | 2.11E−06 |
| M4_6 | 2.82E−07 | 2.29E−07 |
| M6_6 | −2.27E−09 | 1.26E−08 |
| M8_6 | 1.68E−09 | −1.84E−10 |
| M10_6 | −4.14E−11 | 2.11E−12 |

| | |
|---|---|
| f | 30.56 |
| Fno | 6.0 |
| β | −0.111 |
| H | 100.0 |
| L | 343.0 |

Also, Table 4 below lists numerical values corresponding to some conditional expressions for the optical systems 17 according to Numerical Examples 1 to 3 of the embodiment.

TABLE 4

| | Numerical Example | | |
|---|---|---|---|
| | 1 | 2 | 3 |
| Conditional expression (1) δP | 7.35E−05 | 4.92E−05 | 1.43E−05 |
| Conditional expression (11) L/f | 11.24 | 11.34 | 11.19 |
| Conditional expression (12) ν1 | 44.27 | 44.78 | 41.24 |
| Conditional expression (13) ν2 − ν1 | 37.27 | 50.15 | 33.46 |

As described above, each of the optical systems 17 according to Numerical Examples 1 to 3 of the embodiment has high imaging performance since the chromatic aberration resulting from the difference between the field curvatures for different colors is well corrected.

Also, the optical system 17 according to the embodiment includes lenses having aspheric surfaces that are rotationally asymmetric about the optical axis. This enables an effective correction of the field curvatures with a small number of lenses.

Also, in the optical system 17 according to the embodiment, each lens having an aspheric surface that is rotationally asymmetric about the optical axis is made of (formed by) a resin. This makes it possible to form the lens having a rotationally asymmetric aspheric surface easily at low cost.

While the present invention has been described with reference to exemplary embodiments, it is to be understood that the invention is not limited to the disclosed exemplary embodiments. The scope of the following claims is to be accorded the broadest interpretation so as to encompass all such modifications and equivalent structures and functions.

According to the present invention, it is possible to provide an optical system capable of sufficiently reducing chromatic aberration.

This application claims the benefit of Japanese Patent Application No. 2019-021194, filed Feb. 8, 2019, which is hereby incorporated by reference herein in its entirety.

What is claimed is:

1. An optical system comprising a plurality of lenses, wherein the following conditional expression is satisfied:
$$\vert \frac{{Σ}_{i} \frac{1}{{υ}_{i} {N}_{i}^{2}} ( {φ}_{i {1}^{+}} {φ}_{i 2} )}{f} \vert \leq 3 \times 1 {0}^{- 3} ,$$
where f is a focal length of the optical system, i is an order of each of the plurality of lenses counted from an enlargement side, Rᵢ₁ and Rᵢ₂ are curvature radii of lens surfaces of an i-th lens at the enlargement side and a reduction side in a cross section including an optical axis, respectively, Nᵢ and νᵢ are a refractive index and an Abbe number of the i-th lens, respectively, φᵢ₁=(Nᵢ−1)/Rᵢ₁, and φᵢ₂=(1−Nᵢ)/Rᵢ₂.

2. The optical system according to claim 1, wherein the following conditional expression is satisfied:
8.3≤L/f≤12.5,
where L is a distance on the optical axis from a focal point of the optical system at the enlargement side to a reducing plane.

3. The optical system according to claim 1, wherein
the plurality of lenses includes one or more negative lenses and one or more positive lenses, and
the following conditional expressions are satisfied:
35≤νₙ, and
25≤νₚ−νₙ,
where νₙ is an Abbe number of the negative lens having a smallest Abbe number among the one or more negative lenses, and νₚ is an Abbe number of the positive lens having a largest Abbe number among the one or more positive lenses.

4. The optical system according to claim 1, wherein at least one of the plurality of lenses includes an aspheric surface that is rotationally asymmetric about the optical axis.

5. The optical system according to claim 4, wherein the lens including the aspheric surface is made of a resin.

6. The optical system according to claim 4, wherein the lens disposed closest to the reduction side among the plurality of lenses includes the aspheric surface.

7. The optical system according to claim 1, wherein the plurality of lenses includes a positive lens, a negative lens, a positive lens, and a positive lens disposed in this order from the enlargement side.

8. The optical system according to claim 1, wherein the plurality of lenses includes a negative lens, a positive lens, a negative lens, a positive lens, and a negative lens disposed in this order from the enlargement side.

9. The optical system according to claim 1, wherein the plurality of lenses includes a positive lens, a negative lens, a positive lens, a positive lens, and a positive lens disposed in this order from the enlargement side.

10. The optical system according to claim 1, wherein an aperture stop is disposed between a positive lens and a negative lens included in the plurality of lenses, the positive lens being disposed closest to the enlargement side among the plurality of lenses, the negative lens being disposed adjacent to a reduction side of the positive lens.

11. The optical system according to claim 1, wherein the lens surface at the enlargement side of the lens disposed closest to the enlargement side among the plurality of lenses has a convex shape toward the enlargement side.

12. The optical system according to claim 1, wherein the lens surface at the reduction side of the lens disposed closest to the reduction side among the plurality of lenses has a convex shape toward the reduction side.

13. An image reading apparatus comprising:
the optical system according to claim 1; and
a light receiving unit that receives a light flux from an object condensed by the optical system.
